(19) United States
(12) Patent Application Publication
(10) Pub. No.: US 2007/0258867 A1
(43) Pub. Date: Nov. 8, 2007

(54) BIOPOLYMER SYNTHESIS APPARATUS AND METHOD OF SYNTHESIZING BIOPOLYMER USING SAME

(76) Inventors: Sung-min Chi, Hwaseongi-si (KR); Jung-hwan Hah, Hwaseong-si (KR); Kyoung-seon Kim, Suwon-si (KR); Won-sun Kim, Suwon-si (KR)

Correspondence Address: F. CHAU & ASSOCIATES, LLC, 130 WOODBURY ROAD, WOODBURY, NY, 11797, US

(21) Appl. No.: 11/738,042

(22) Filed: Apr. 20, 2007

(30) Foreign Application Priority Data
May 8, 2006 (KR) 10-2006-0041035

(51) Int. Cl. B01J 19/00

(52) U.S. Cl. 422/130

(57) ABSTRACT

A biopolymer synthesis apparatus including at least one chamber in which a biopolymer is to be synthesized includes a chamber body and a chamber cover covering the chamber body, wherein the chamber cover includes at least one through hole at an upper surface thereof, and at least one first fluid-supply pipe coupled with the chamber via the at least one through-hole of the chamber cover.

### CROSS-REFERENCE TO RELATED PATENT APPLICATION

This application claims priority to Korean Patent Application No. 10-2006-0041035, filed on May 8, 2006, the disclosure of which is herein incorporated by reference in its entirety.

### BACKGROUND OF THE INVENTION

1. Technical Field

The present disclosure relates to a biopolymer synthesis apparatus and, more particularly, to a biopolymer synthesis apparatus and a method of synthesizing a biopolymer using the apparatus.

2. Discussion of Related Art

In recent years, with the advance of genome projects, the genomic nucleotide sequences of various organisms have been identified. For example, the Human Genome Project has generated a substantial body of DNA sequence information. To take advantage of the latest information, there has been an increasing interest in microarrays (also commonly known as gene chips, DNA chips, or biochips) and, in particular, oligomeric probe arrays. Oligomeric probe arrays are tools that have been used in gene expression profiling, genotyping, detection of mutation or polymorphism such as Single-Nucleotide Polymorphism (SNP), assaying of proteins or peptides, and drug screening studies.

Currently available oligomeric probe arrays include probe cell arrays that are manufactured using a combination of semiconductor-based photolithography and solid phase chemical synthesis technologies. For example, cell arrays have been manufactured by activating predetermined regions of substrates using light irradiation followed by in-situ synthesis of oligomeric probes in the photo-activated regions.

However, the in-situ synthesis of oligomeric probes requires a series of a photolithography processes, and each photolithography process involves the repetition of reagent addition and cleaning, resulting in higher complexity. For example, to synthesize probes of 25 nucleotides in length (25-mer), 100 repetitions of a photolithography process may be needed. In a case where each photolithography process involves four repetitions of reagent addition and cleaning, the reagent addition and the cleaning are repeated a total of 400 times, thereby decreasing process efficiency.

Furthermore, the substrate is exposed to the environment for a longer time during the reagent addition or the cleaning, or between the reagent addition and the cleaning, thereby increasing the probability of probe contamination.

A need exists for an oligomer probe synthesis apparatus to improve process efficiency and reduce the level of probe contamination.

### SUMMARY OF THE INVENTION

According to an exemplary embodiment of the present invention, a biopolymer synthesis apparatus including at least one chamber in which a biopolymer is to be synthesized includes a chamber body and a chamber cover covering the chamber body, wherein the chamber cover includes at least one through-hole at an upper surface thereof, and at least one first fluid-supply pipe coupled with the chamber via the at least one through-hole of the chamber cover.

According to an exemplary embodiment of the present invention a method of manufacturing a microarray includes providing a substrate including a functional group capable of reacting with a nucleotide phosphoramidite monomer, supplying a nucleotide phosphoramidite monomer with a photolabile protecting group to the substrate and coupling the nucleotide phosphoramidite monomer with the photolabile protecting group to the functional group of the substrate, capping an unreacted functional group on the substrate, and oxidizing a monomer coupled to the functional group on the substrate, wherein the coupling, the capping, and the oxidation are performed in a closed chamber.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a perspective view illustrating a biopolymer synthesis apparatus according to an exemplary embodiment of the present invention.

FIG. 2 is an enlarged perspective view of a chamber of the biopolymer synthesis apparatus of FIG. 1.

FIG. 3 is a schematic sectional view of the chamber of FIG. 2.

FIG. 4 is a plan view of a chamber cover according to an exemplary embodiment of the present invention.

FIG. 5 is a perspective view of a chamber body according to an exemplary embodiment of the present invention.

FIG. 6 is a structural view illustrating a fluid supply pipe of a biopolymer synthesis apparatus according to an exemplary embodiment of the present invention.

FIG. 7 is a structural view illustrating a second discharge pipe of a biopolymer synthesis apparatus according to an exemplary embodiment of the present invention.

FIG. 8 is a perspective view illustrating a chamber of a biopolymer synthesis apparatus according to an exemplary embodiment of the present invention.

FIGS. 9 through 12 are sequential perspective views illustrating a method of manufacturing a microarray according to an exemplary embodiment of the present invention.

### DESCRIPTION OF EXEMPLARY EMBODIMENTS

Hereinafter, exemplary embodiments of the present invention will be described in detail with reference to the accompanying drawings. Like reference numerals refer to similar or identical elements throughout description of the figures.

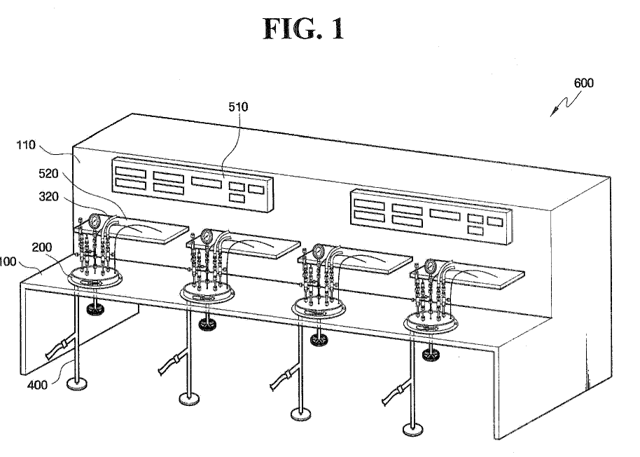

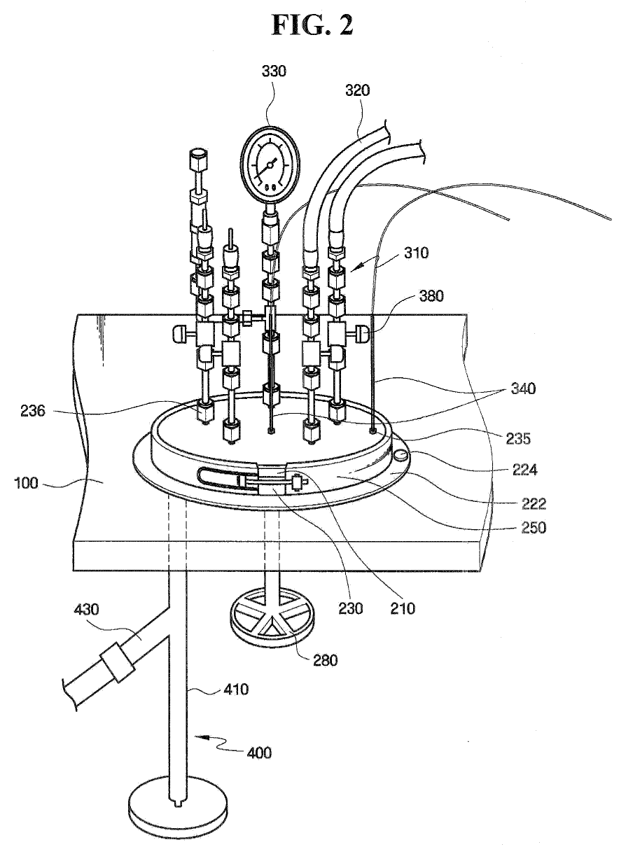

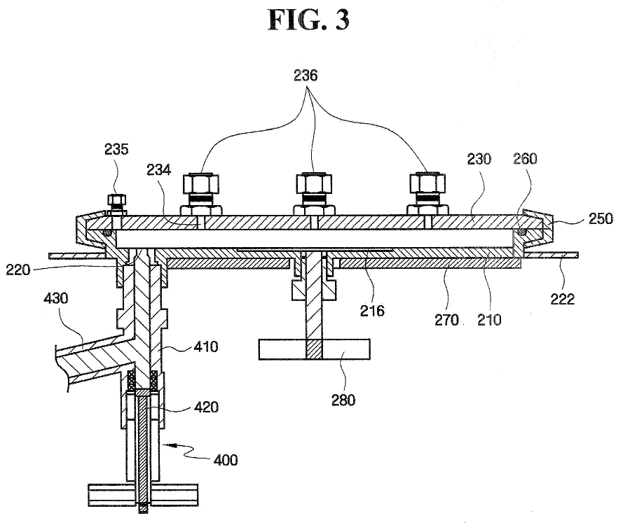

FIG. 1 is a perspective view illustrating a biopolymer synthesis apparatus according to an exemplary embodiment of the present invention. FIG. 2 is an enlarged perspective view of a chamber of the biopolymer synthesis apparatus of FIG. 1. FIG. 3 is a schematic sectional view of the chamber of FIG. 2. In the interests of simplicity, a connection pipe 310 and a fluid supply pipe 320 of FIG. 2 are not shown in FIG. 3.

Referring to FIGS. 1 through 3, a biopolymer synthesis apparatus according to an exemplary embodiment of the present invention includes at least one chamber and at least one fluid supply pipe coupled with the chamber.

As used herein, the term “biopolymer” refers to a biological material synthesized in an organism or a biological material constituting an organism. Biopolymers are composed of two or more covalently bonded monomers. For example, the monomers may be nucleosides, nucleotides, amino acids or peptides.

As used herein, the terms “nucleoside” or “nucleotide” refer to a purine or pyrimidine base, a methylated purine or pyrimidine, an acylated purine or pyrimidine, and the like. For example, a nucleoside or a nucleotide may include a ribose or deoxyribose glycoside and may also include a modified glycoside with at least one hydroxyl group substituted with halogen or aliphatic group or attached to a functional group, such as for example, an ether or amine.

As used herein, the term “amino acid” refers to the L-, D- and nonchiral forms of naturally occurring amino acids, modified amino acids, amino acid analogs, and the like.

As used herein, the term “peptide” refers to a chemical compound generated by an amide bond between a carboxyl group in an amino acid and an amino group of other amino acids.

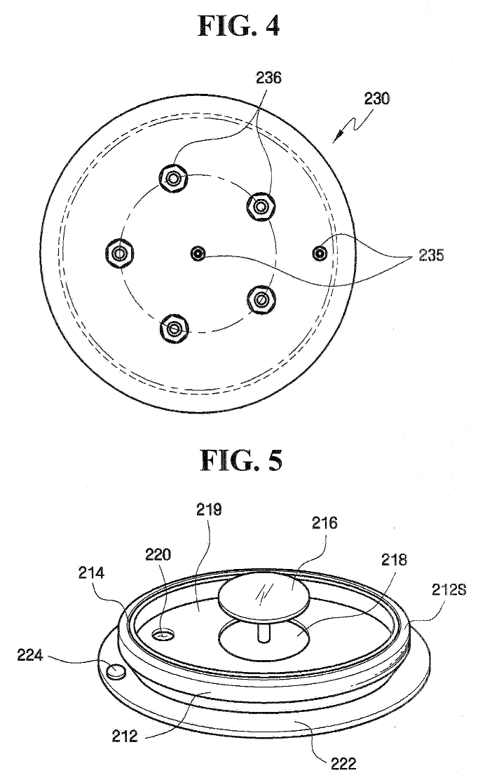

In an exemplary embodiment of the present invention, biopolymers are synthesized in a chamber 200 disposed on a support 100. The chamber 200, according to an exemplary embodiment of the present invention, includes a chamber body 210 and a chamber cover 230 that can be separated from the chamber body 210. FIG. 4 is a plan view of a chamber cover according to an exemplary embodiment of the present invention, which will be described later in this disclosure.

FIG. 5 is a perspective view of a chamber body according to an exemplary embodiment of the present invention. Referring to FIG. 5 and FIGS. 1 through 3, the chamber body 210 includes a bottom surface 219 and a sidewall 212 vertically extended from an edge portion of the bottom surface 219. The bottom surface 219 of the chamber body 210 may have substantially the same shape as a substrate on which a biopolymer is to be synthesized (hereinafter, simply referred to as “biopolymer synthesis substrate”). For example, in a case where a biopolymer synthesis substrate is a circular wafer, the bottom surface 219 of the chamber body 210 may have a circular shape. In a case where a biopolymer synthesis substrate is a rectangular glass substrate, the bottom surface 219 of the chamber body 210 may have a rectangular shape. The bottom surface 219 of the chamber body 210 may have substantially the same size as a biopolymer synthesis substrate. In an exemplary embodiment of the present invention, bottom surface 219 of the chamber body 210 has a larger width than that of a biopolymer synthesis substrate to provide a margin for the discharge of a fluid, such as a sample.

The bottom surface 219 of the chamber body 210 includes at least one outlet 220. The outlet 220 may be connected integrally to a discharge unit 400, as will be described later in this disclosure. The outlet 220 may also be coupled with the discharge unit 400 by coupling the discharge unit 400 with a downward projection of the chamber body 210. A fluid supplied into the chamber 200 is discharged through the outlet 220 and the discharge unit 400 that is coupled with the outlet 220.

The sidewall 212 of the chamber body 210, together with the bottom surface 219, provides a space for biopolymer synthesis. For example, the height of the chamber body 210 is related to the volume of a space in which biopolymer synthesis occurs in the presence of a fluid, etc. In an exemplary embodiment of the present invention, the height of the chamber body 210 can be appropriately selected according to the type and use of a biopolymer to be synthesized and/or the type of substrate. Referring to FIG. 5, an upper surface 212s of the sidewall 212 extends outward and has a predetermined width. The upper surface 212s of the sidewall 212 acts as a binding surface for the chamber cover 230.

The chamber body 210 may have a sealing groove 214 along the upper surface 212s of the sidewall 212. An O-ring 260 may be disposed in the sealing groove 214, for example, to increase a sealing property between the chamber body 210 and the chamber cover 230.

A stage 216 for mounting a biopolymer synthesis substrate is disposed in the center region of the chamber body 210. The stage 216 is coupled with a handle 280 for moving the stage 216, such as in an upward or downward direction. For example, when the handle 280 is rotated in a clockwise direction, the stage 216 may be elevated upward. On the other hand, when the handle 280 is rotated in a counterclockwise direction, the stage 216 may be lowered downward. The size of the stage 216 may be smaller than that of a biopolymer synthesis substrate, for example, facilitating the placement and removal of the substrate.

A stage-receiving surface 218 is disposed in the center region of the chamber body 210. The stage-receiving surface 218, which is surrounded by the bottom surface 219, may be recessed to a predetermined depth relative to the bottom surface 219. The stage-receiving surface 218 may have substantially the same shape as the stage 216 such that when the stage is lowered downward, the stage 216 can be completely received on the stage-receiving surface 218. The stage-receiving surface 218 may have substantially the same size as the stage 216 and substantially the same depth as the thickness of the stage 216 such that when the stage 216 is completely received in the stage-receiving surface 218, there is little or no gap between the stage 216 and the bottom surface 219, and the stage 216 is at substantially the same level as the bottom surface 219.

A support plate 222 may be disposed around an outer edge of the chamber body 210. The support plate 222 may be directly attached to the chamber body 210 or may be formed integrally with the chamber body 210. The support plate 222 may be detachably disposed around the outer edge of the chamber body 210 to support the outer edge of the chamber body 210. In an exemplary embodiment of the present invention, the support plate 222 is clamped to the support 100 using a clamp screw 224, and the chamber body 210 can be stably fixed to the support 100.

A heater 270 for heating an internal space of the chamber 200 may be disposed on a surface, such as a lower surface, of the chamber body 210. For example, the heater 270 may be an electrical heater, which may be capable of easily turning heating on and off and controlling a heating temperature.

FIG. 4 is a plan view illustrating an exemplary embodiment of the chamber cover 230. Referring to FIGS. 1 through 4, the chamber cover 230 has substantially the same shape as the bottom surface 219 of the chamber body 210. The chamber cover 230 may have, for example, a flat plate shape. The chamber cover 230 may have a convex shape, which may enlarge the internal space of the chamber 200. The chamber cover 230 may have substantially the same size as an area defined by an outer edge of the upper surface 212s of the sidewall 212 of the chamber body 210. In such case, when the chamber cover 230 is coupled to the chamber body 210, an edge of the chamber cover 230 is closely contacted to the upper surface 212s of the sidewall 212 of the chamber body 210. An O-ring 260 may be interposed between the chamber cover 230 and the chamber body 210 to increase a sealing property between the chamber cover 230 and the chamber body 210.

The chamber cover 230 may be coupled to the chamber body 210 with a holding device such as a clamp 250. For example, the clamp 250 may be fastened to surround the outer surface of the sidewall 212 of the chamber body 210 and the outer side surface of the chamber cover 230. In an exemplary embodiment of the present invention, the chamber 200 comprises a chamber body 210, a chamber cover 230, an O-ring 260, and a clamp 250, and the entry of an external contaminant into the chamber 200, such as via a gap between the chamber body 210 and the chamber cover 230, may be prevented during biopolymer synthesis.

The chamber cover 230 includes one or more through-holes 234 at an upper surface thereof, as shown in FIG. 3. The through-holes 234 spatially connect the internal space inside the chamber 200 and the ambient space outside the chamber. First and second connectors 235 and 236, which are disposed on the outer surface of the chamber cover 230, may be arranged to correspond to the through-holes 234. In an exemplary embodiment of the present invention described in connection with FIG. 4, seven through-holes (not shown) are formed in a chamber cover 230, wherein first connectors 235 are held in position at two through-holes formed at the central and edge portions of the chamber cover 230, and wherein second connectors 236 are held in position at five through-holes formed in a circular arrangement around the central first connector 235. However, it should be understood that the chamber cover 230 may be embodied using various numbers and arrangements of the through-holes 234, the first connectors 235, and the second connectors 236.

As shown in FIG. 2, sensors 340 are coupled with the first connectors 235. For example, the sensors 340 may be temperature sensors or humidity sensors. One end of each of the sensors 340 may be fixedly contacted to the chamber cover 230 via a corresponding through-hole 234 and/or may extend into the internal space of the chamber 200 to detect various conditions inside the chamber 200. The other end of each of the sensors 340 may be electrically connected to a control box 510, which may be installed at a support wall 110.

Connection pipes 310 are coupled with the second connectors 236. The connection pipes 310 may include switch valves 380. One or more of the connection pipes 310 may be coupled with the fluid supply pipes 320. The fluid supply pipes 320 may be coupled with the fluid supply tanks (not shown). The fluid supply tanks may contain various samples or cleaning solutions required for biopolymer synthesis. Thus samples or cleaning solutions can be supplied into the chamber 200 from the fluid supply tanks via the fluid supply pipes 320, the corresponding connection pipes 310, and the corresponding through-holes 234.

The switch valves 380 coupled with the connection pipes 310 control the supply of fluids, such as samples or cleaning solutions, etc. In an exemplary embodiment of the present invention, switch valves may be installed at the fluid supply pipes 320 and/or the fluid supply tanks, and the switch valves 380 of the connection pipes 310 can be omitted.

The connection pipes 310 may be respectively coupled with the different fluid supply tanks. Thus, various samples or cleaning solutions can be independently supplied to the chamber 210 continuously or at predetermined time intervals by controlling the switch valves 380 without separating the chamber cover 230 from the chamber body 210.

For example, in the case of synthesizing oligonucleotides using a photolithography process, four or more different fluid supply tanks can be used, e.g., a first fluid supply tank for supplying a nucleotide phosphoramidite monomer having a photolabile protecting group attached thereto to couple the monomer with a substrate or a monomer previously attached to the substrate, a second fluid supply tank for supplying acetic anhydride and/or N-methylimidazole to render unreacted functional groups inactive by capping, a third fluid supply tank for supplying iodine to oxidize a phosphite structure to a phosphate structure, and a fourth fluid supply tank for supplying a cleaning solution to clean the chamber 200 after the monomer coupling, the capping, or the oxidation. Such a fluid supply can be performed in a state in which the chamber 200 is sealed, which may decrease the entry of external contaminants and improve process efficiency.

Meanwhile, one or more connection pipes 310 that are not connected to the fluid supply pipes 320 may be used as pressure controllers. For example, a pressure gauge 330 may be coupled with one of the connection pipes 310 that are not connected to the fluid supply pipes 320. The pressure gauge 330 may display an internal pressure of the chamber 200 using the corresponding through-hole 234 and the corresponding connection pipe 310.

In a case when the internal pressure of the chamber 200 is greater than a predetermined pressure required for biopolymer synthesis, the switch valves 380 of the connection pipes 310 that are not connected to the fluid supply pipes 320 or the pressure gauge 330 are turned to the open position to discharge a pressurized gas from the chamber 200. To prevent internal contamination of the chamber 200 during the pressure discharge process, an air filter (not shown) may be employed. The filters may be coupled with each of the connection pipes 310, for example, at the ends thereof where the gas discharge occurs.

As shown in FIGS. 1 through 3, the discharge unit 400 includes a first discharge pipe 410 and a second discharge pipe 430 that branches from the first discharge pipe 410. The first discharge pipe 410 is coupled with the outlet 220 of the chamber body 210 and may include a piston 420 therein. The piston 420 controls a spatial connection between the outlet 220 and/or the first discharge pipe 410 and the second discharge pipe 430 while it is elevated or lowered along the first discharge pipe 410. For example, when a head of the piston 420 is positioned higher than an inlet of the second discharge pipe 430, the second discharge pipe 430 is closed, and discharge of a sample or a cleaning solution from the chamber 200 does not occur. On the other hand, when the head of the piston 420 is positioned lower than the inlet of the second discharge pipe 430, the outlet 220 and/or the first discharge pipe 410 and the second discharge pipe 430 are spatially connected, and a sample or a cleaning solution can be discharged from the chamber 200. The discharged sample or a cleaning solution may be treated in a treatment system (not shown).

Fluid supply pipes, fluid supply tanks and discharge units according to exemplary embodiments of the present invention described in connection with FIGS. 1-5 can be coupled with a plurality of chambers 200. For example, as illustrated in FIG. 1, in a case where a biopolymer synthesis apparatus includes four chambers, each of the chambers includes fluid supply pipes, fluid supply tanks and a discharge unit.

Two or more different biomonomers can be coupled in each chamber. Different biomonomers can be coupled in respective chambers. For example, in the case of synthesizing oligonucleotides containing various combinations of four bases, such as adenine (A), guanine (G), thymine (T) and cytosine (C), using a photolithography process, a first chamber may be coupled with a fluid supply tank for the supply of adenine (A) nucleotide phosphoramidite monomers having photolabile protecting groups attached thereto, a second chamber may be coupled with a fluid supply tank for the supply of guanine (G) nucleotide phosphoramidite monomers having photolabile protecting groups attached thereto, a third chamber may be coupled with a fluid supply tank for the supply of thymine (T) nucleotide phosphoramidite monomers having photolabile protecting groups attached thereto, and a fourth chamber may be coupled with a fluid supply tank for the supply of cytosine (C) nucleotide phosphoramidite monomers having photolabile protecting groups attached thereto. It is to be understood that various fluid supply tanks, such as for example, a fluid supply tank for the supply of a capping agent, a fluid supply tank for the supply of an oxidizing agent, and/or a fluid supply tank for the supply of a cleaning solution, can also be coupled with each chamber.

In a case where the same nucleotide monomers are coupled in each chamber, unwanted nucleotides may not be left in each chamber, which may ensure a more accurate synthesis of biopolymers.

Referring to FIGS. 1 through 5, the support 100 is partially bored to configure the chamber 200 and the discharge unit 400 that is coupled with the chamber 200. The bored area of the support 100 is smaller than the area of the chamber body 210. The chamber 200 can be fixed on the support 100, for example, using the clamp screw 224 and the support plate 222.

A side of the support 100 may be attached to the support wall 110 that is oriented vertically with respect to the support 100, as shown in FIG. 1. At least one receiving board 520 extends from a portion of the support wall 110 that corresponds to an area located above the support 100. The receiving board 520 is configured to support the chamber cover 230 and/or the clamp 250 when separated from the chamber body 210, and may provide a workspace.

The control box 510 may be installed at a portion of the support wall 110 above the receiving board 520. The control box 510 may include a temperature controller and/or a heating controller. The control box 510 may also include a display unit for displaying the temperature and/or humidity detected by the sensors 340, which may be attached to the chamber cover 230. In an exemplary embodiment of the present invention, the control box 510 can be programmed to indicate the differences between desired parameter (e.g., temperature or humidity) values and detected parameter values, and reaction conditions can be controlled in a precise manner.

Hereinafter, biopolymer synthesis apparatuses according to exemplary embodiments of the present invention will be described.

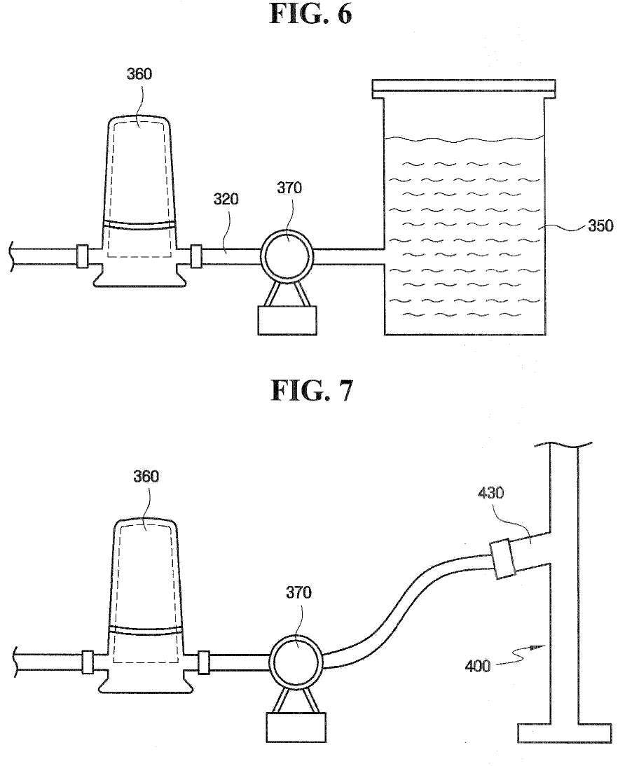

FIG. 6 is a structural view illustrating a fluid supply pipe of a biopolymer synthesis apparatus according to an exemplary embodiment of the present invention. Referring to FIG. 6, a biopolymer synthesis apparatus includes a filter 360 coupled with a fluid supply pipe 320. The filter 360 may increase the purity of a fluid supplied from a fluid supply tank 350 using a filtering action. To make it possible for the fluid to pass through the filter 360, a predetermined pressure may be needed. Thus, a pump 370 may be interposed between the fitter 360 and the fluid supply tank 350. Such fluid filtering can increase the purity of biopolymers and may increase the quality of biopolymer synthesis.

FIG. 7 is a structural view illustrating a second discharge pipe of a biopolymer synthesis apparatus according to an exemplary embodiment of the present invention. Referring to FIG. 7, a biopolymer synthesis apparatus includes a filter 360 installed at a second discharge pipe 430. A pump 370 may be installed at the second discharge pipe 430, for example, in front of the filter 360. A fluid that has been used for biopolymer synthesis in a chamber (not shown) can be discharged after being filtered through the filter 360 and pumped through the pump 370. The discharged fluid can be recycled to a fluid supply tank (not shown).

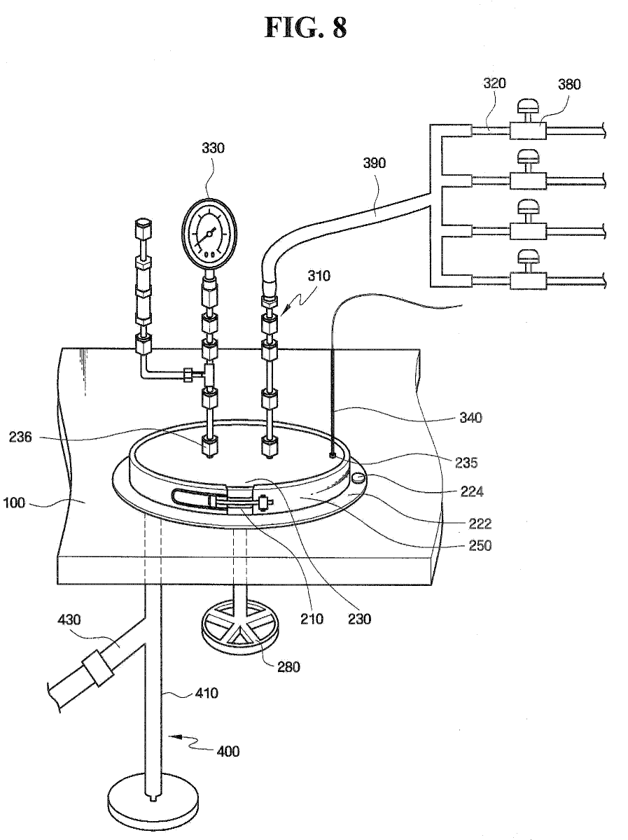

FIG. 8 is a perspective view illustrating a chamber of a biopolymer synthesis apparatus according to an exemplary embodiment of the present invention. Referring to FIG. 8, a plurality of fluid supply pipes 320 coupled with a plurality of fluid supply tanks (not shown) are coupled with a second connector 236 via a fluid junction pipe 390. Switch valves 380 are coupled with the fluid supply pipes 320 to selectively supply fluids for the respective processes. Although a chamber of a biopolymer synthesis apparatus according to an exemplary embodiment of the present invention described in connection with FIG. 8 includes a single second connector 236, it is to be understood that a plurality of second connectors can be used. Each of the second connectors can be connected to a fluid junction pipe.

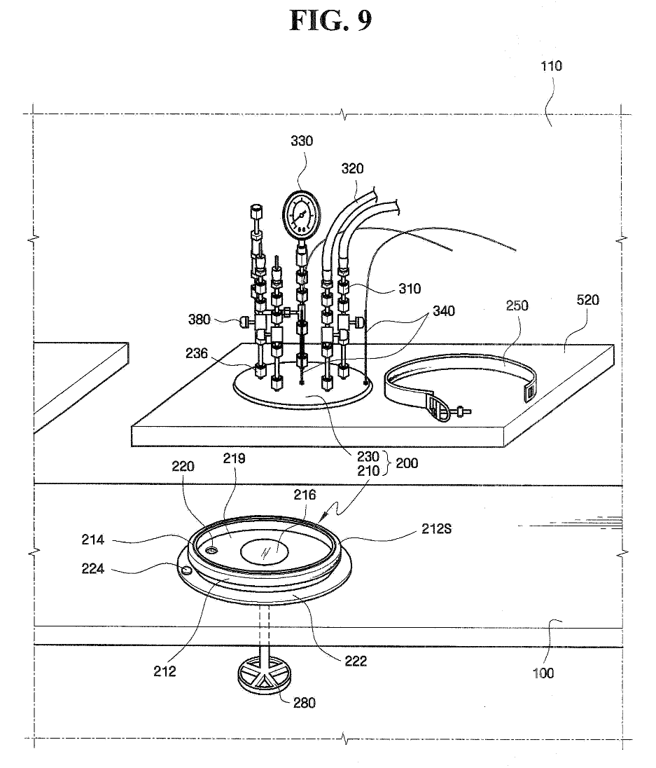

Hereinafter, a method of manufacturing a microarray according to an exemplary embodiment of the present invention will be described with reference to FIGS. 9 through 12. In the interests of clarity, synthesis of oligonucleotides using a biopolymer synthesis apparatus according to an exemplary embodiment of the present invention described in connection with FIG. 1 will be described. However, it should be understood that a biopolymer synthesis apparatus according to exemplary embodiments of the present invention may be embodied in various configurations for implementing a method of manufacturing a microarray.

FIGS. 9 through 12 are sequential perspective views for illustrating a method of manufacturing a microarray according to an exemplary embodiment of the present invention. Referring to FIG. 9, a chamber 200, which may be coupled with a fluid supply tank (not shown) including target monomers, for example, adenine nucleotide phosphoramidite monomers having photolabile protecting groups attached thereto, is selected. The selected chamber 200 is opened. For example, a chamber body 210 and a chamber cover 230 are separated from each other by releasing a clamp 250 that holds together the chamber body 210 and the chamber cover 230. The separated clamp 250 and the chamber cover 230 are placed on a receiving board 520.

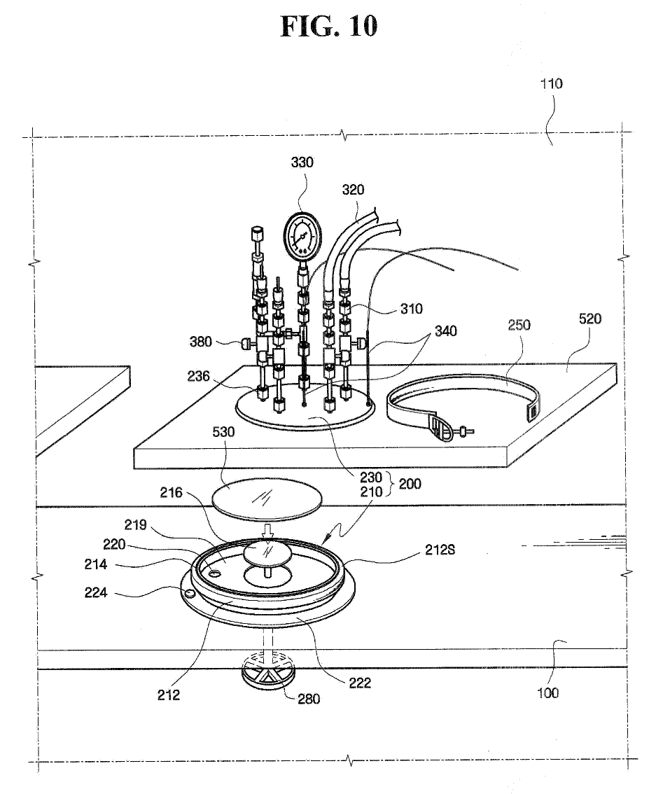

Referring to FIG. 10 and FIG. 9, a handle 280 for moving a stage 216 is rotated in a clockwise direction (or in a counterclockwise direction) such that the stage 216 is elevated to a position above an upper surface 212s of a sidewall 212 of the chamber body 210. A substrate 530, which may include functional groups capable of reacting with adenine monomers, is placed on the stage 216.

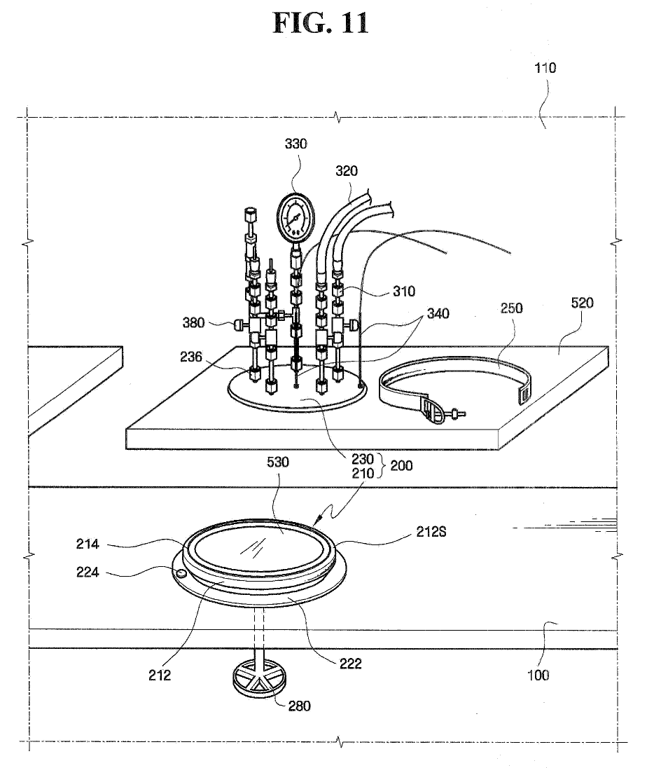

Next, referring to FIG. 11 and FIG. 10, the handle 280 is rotated in a counterclockwise direction (or in a clockwise direction) to lower the stage 216 downward. In an exemplary embodiment of the present invention, the stage 216 is lowered downward such that an upper surface of the stage 216 is at substantially the same level as a bottom surface 219 of the chamber body 210.

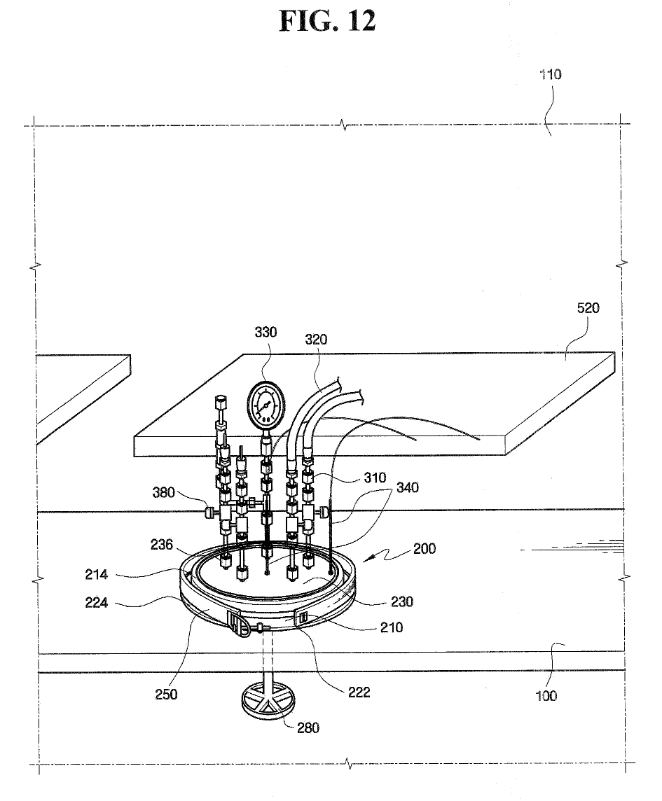

Referring to FIG. 12 and FIG. 11, the chamber cover 230 is positioned on the chamber body 210, and the clamp 250 is clamped to hold the chamber cover 230 and the chamber body 210 together.

A switch valve 380 of a fluid supply pipe 320 coupled with the fluid supply tank containing the adenine nucleotide phosphoramidite monomers having photolabile protecting groups attached thereto and/or a connection pipe 310 coupled with the fluid supply pipe 320 is turned to the open position to supply the monomers into the chamber 200, such that the monomers may be coupled to the functional groups of the substrate 530. At this time, the reaction conditions (e.g., temperature, humidity, pressure and reaction time) inside the chamber 200 are controlled by a control box (not shown). A heater (not shown) may be employed. At this time, although not shown, a head of a piston of a discharge unit is positioned higher than a second discharge pipe such that fluid discharge from the chamber 200 does not occur.

When a predetermined reaction time is reached, the piston of the discharge unit is lowered downward to discharge the monomers via the second discharge pipe. After or simultaneously with the monomer discharge, a switch valve 380 of a fluid supply pipe 320 coupled with a fluid supply tank (not shown) containing a cleaning solution and/or a connection pipe 310 coupled with the fluid supply pipe 320 is turned to the open position to supply the cleaning solution into the chamber 200 to clean the chamber 200.

Next, a capping agent, e.g., acetic anhydride and/or N-methylimidazole, is supplied into the chamber 200 to cap or inactivate unreacted functional groups on the substrate 530. The supply of the capping agent into the chamber 200 may be performed in substantially the same manner as the above-described monomer supply. However, to completely remove a residual cleaning solution in the chamber 200, the capping agent is supplied for a predetermined time in a state wherein the second discharge pipe is opened, and when the residual cleaning solution is completely removed, the second discharge pipe is closed so that the capping agent is not discharged. After the capping is performed, the chamber 200 may be cleaned, for example, as described above.

An oxidation process may performed, for example, to convert phosphite triester structures produced in the coupling process to phosphate triester structures. For this, an oxidizing agent, e.g., iodine, is supplied into the chamber 200. The supply of the oxidizing agent into the chamber 200 and the oxidation process are performed in substantially the same manner as the supply of the capping agent and the capping. After the oxidation process is completed, the chamber 200 is cleaned as described above.

Next, as described above with reference to FIG. 9, the chamber body 210 and the chamber cover 230 are separated from each other, and the handle 280 is rotated in a clockwise direction (or in a counterclockwise direction) to elevate the stage 216 above the upper surface 212s of the sidewall 212 of the chamber body 210. The substrate 530 can be removed from the stage 216. The substrate 530 may be transferred to a photolithographic chamber (not shown). For example, in the photolithographic chamber, the substrate 530 may be exposed to light using a mask to selectively remove the photolabile protecting groups on the substrate 530 such that functional groups capable of reacting with the next monomers are exposed.

A method of manufacturing a microarray according to an exemplary embodiment of the present invention described in connection with FIGS. 10 through 12 may be repeated using predetermined nucleotides to be attached to the exposed functional groups and a plurality of oligonucleotide probes may be completed.

To perform hybridization of targets with the synthesized oligonucleotide probes, the amino-protected sites of the oligonucleotide probes are deprotected. For example, the deprotection can be performed using a deprotection solution such as ammonium hydroxide, diaminoethane, tertiary butylamine, potassium carbonate, or ethanolamine, for a predetermined time, in the same manner as the above-described capping with the capping agent, and a microarray immobilized with oligonucleotide probes having different nucleotide sequences in which oligonucleotide probes having the same sequence are coupled to respective active areas may be produced.

In a biopolymer synthesis apparatus according to an exemplary embodiment of the present invention, monomer coupling, capping, oxidation, and cleaning processes for polymer synthesis can be continuously performed in a single closed chamber, such that process efficiency may be increased and contamination due to entry of a foreign substance into the chamber may be prevented.

Although exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments may be made without departing from the scope of the invention as defined by the appended claims, with equivalents of the claims to be included therein.

What is claimed is:

1. A biopolymer synthesis apparatus comprising:
at least one chamber in which a biopolymer is to be synthesized including a chamber body and a chamber cover covering the chamber body, wherein the chamber cover includes at least one through-hole at an upper surface thereof; and
at least one fluid-supply pipe coupled with the chamber via the at least one through-hole of the chamber cover.

2. The biopolymer synthesis apparatus of claim 1, wherein a bottom surface of the chamber body has substantially the same shape as a substrate on which the biopolymer is to be synthesized.

3. The biopolymer synthesis apparatus of claim 1, wherein a nucleotide phosphoramidite monomer with a photolabile protecting group is supplied into the chamber via the at least one fluid-supply pipe.

4. The biopolymer synthesis apparatus of claim 3, wherein the nucleotide comprises at least one of adenine, guanine, thymine or cytosine.

5. The biopolymer synthesis apparatus of claim 3, wherein the at least one fluid-supply pipe comprises at least one first fluid-supply pipe and at least one second fluid-supply pipes wherein the nucleotide phosphoramidite monomer with a photolabile protecting group is supplied into the chamber via the first fluid-supply pipe, and a capping agent or an oxidizing agent is supplied into the chamber via the second fluid-supply pipe.

6. The biopolymer synthesis apparatus of claim 1, wherein the at least one fluid-supply pipe is configured to be independently closed or opened.

7. The biopolymer synthesis apparatus of claim 1, comprising two or more chambers, wherein different nucleotide phosphoramidite monomers with photolabile protecting groups having different bases are supplied to the two or more chambers, respectively.

8. The biopolymer synthesis apparatus of claim 7, wherein each of the two or more chambers is coupled with a plurality of fluid-supply pipes, and wherein a capping agent or an oxidizing agent is also supplied into each chamber via at least one of the fluid-supply pipes.

9. The biopolymer synthesis apparatus of claim 8, wherein the fluid-supply pipes of each chamber are configured to be independently closed or opened.

10. The biopolymer synthesis apparatus of claim 1, further comprising a fluid junction pipe coupled between each fluid-supply pipe and corresponding through-hole.

11. The biopolymer synthesis apparatus of claim 10, wherein the at least one fluid-supply pipe is configured to be independently closed or opened.

12. The biopolymer synthesis apparatus of claim 10, wherein each fluid-supply pipe is coupled with a respective fluid supply tank for supplying a fluid, and wherein a filter for filtering the fluid supplied from the fluid supply tank is coupled with each fluid-supply pipe.

13. The biopolymer synthesis apparatus of claim 1, further comprising a discharge unit coupled with an outlet formed at a lower surface of the chamber.

14. The biopolymer synthesis apparatus of claim 13, wherein the discharge unit comprises:
a first discharge pipe coupled with the outlet;
a second discharge pipe that branches from the first discharge pipe; and
a piston, disposed in the first discharge pipe, controlling a spatial connection between the outlet and the second discharge pipe.

15. The biopolymer synthesis apparatus of claim 1, further comprising a stage disposed in the chamber body configured to be moved in an upward or downward direction and receive a substrate.

16. The biopolymer synthesis apparatus of claim 1, further comprising a heater disposed on a surface of the chamber body.

17. The biopolymer synthesis apparatus of claim 1, further comprising a sensor coupled with the through-hole, wherein the sensor detects a reaction condition inside the chamber.

18. The biopolymer synthesis apparatus of claim 1, further comprising a clamp disposed on outer surfaces of the chamber body and the chamber cover, wherein the clamp holds the chamber body and the chamber cover together.

19. A method of manufacturing a microarray, the method comprising:
providing a substrate including a functional group capable of reacting with a nucleotide phosphoramidite monomer;
supplying a first nucleotide phosphoramidite monomer with a photolabile protecting group to the substrate and coupling the first nucleotide phosphoramidite monomer with the photolabile protecting group to the functional group of the substrate;
capping an unreacted functional group on the substrate; and
oxidizing a monomer coupled to the functional group on the substrate,
wherein the coupling, the capping, and the oxidation are performed in a closed chamber.

20. The method of claim 19, further comprising:
after the oxidation step, exposing the substrate to light to selectively remove the photolabile protecting group such that a functional group capable of reacting with a second nucleotide phosphoramidite monomer with a second photolabile protecting group is exposed; and
repeating the coupling, the capping and the oxidation steps.
